(19) United States
(12) Patent Application Publication
(10) Pub. No.: US 2026/0360070 A1
(43) Pub. Date: Nov. 12, 2026

(54) NEURAL HASH GRID BASED MULTI-SENSOR SIMULATION

(71) Applicant: WAABI Innovation Inc., Toronto (CA)

(72) Inventors: Ze YANG, Toronto (CA); Yun CHEN, Toronto (CA); Jingkang WANG, Toronto (CA); Sivabalan MANIVASAGAM, Toronto (CA); Wei-chiu MA, Toronto (CA); Raquel URTASUN, Toronto (CA)

(73) Assignee: WAABI Innovation Inc., Toronto, ON (CA)

(21) Appl. No.: 19/114,282

(22) PCT Filed: Nov. 10, 2023
(86) PCT No.: PCT/CA2023/051509

§ 371 Date: Mar. 21, 2025

Related U.S. Application Data
(60) Provisional application No. 63/424,865, filed on Nov. 11, 2022.

(51) Int. Cl. G06T 15/06; G06T 3/4053; G06V 10/82

(52) U.S. Cl. CPC G06T 15/06; G06T 3/4053; G06V 10/82

(57) ABSTRACT

Neural hash grid based sensor simulation includes interpolating hash grid features adjacent to a location in a neural hash grid defined for a target object to obtain a set of location features. A multilayer perceptron (MLP) model processes the set of location features to generate a set of image features for the location. The method further includes completing, using the set of image features, ray casting to the target object to generate a feature image, generating a rendered image from the feature image, and processing the rendered image.

### CROSS-REFERENCE TO RELATED APPLICATIONS

This application is a non-provisional application of, and thereby claims benefit to U.S. Patent Application Ser. No. 63/424,865 filed on Nov. 11, 2022, which is incorporated herein by reference in its entirety.

### BACKGROUND

A virtual world is a computer-simulated environment, which enables a player to interact in a three-dimensional space as if the player were in the real world. In some cases, the virtual world is designed to replicate at least some aspects of the real world. For example, the virtual world may include objects and background reconstructed from the real world. The reconstructing of objects and background from the real world allows the system to replicate aspects of the real world.

For example, one way to bring realism is by obtaining sensor data from the real world describing a scenario, modifying the scenario to create a modified scenario, and then allowing the player to interact with the modified scenario. When the player interacts with the modified scenario, different objects may be in different relative positions than in the real world. Thus, in order to modify the real world, an accurate set of models should be created and used in the virtual world.

### SUMMARY

In general, in one aspect, one or more embodiments relate to a method that includes interpolating hash grid features adjacent to a location in a neural hash grid defined for a target object to obtain a set of location features. A multilayer perceptron (MLP) model processes the set of location features to generate a set of image features for the location. The method further includes completing, using the set of image features, ray casting to the target object to generate a feature image, generating a rendered image from the feature image, and processing the rendered image.

In general, in one aspect, one or more embodiments relate to a system that includes memory and a computer processor that includes computer readable program code for performing operations. The operations include interpolating hash grid features adjacent to a location in a neural hash grid defined for a target object to obtain a set of location features. A multilayer perceptron (MLP) model processes the set of location features to generate a set of image features for the location. The operations further include completing, using the set of image features, ray casting to the target object and volume rendering to generate a feature image, generating a rendered image from the feature image, and processing the rendered image.

In general, in one aspect, one or more embodiments relate to a non-transitory computer readable medium that includes computer readable program code for performing operations. The operations include interpolating hash grid features adjacent to a location in a neural hash grid defined for a target object to obtain a set of location features. A multilayer perceptron (MLP) model processes the set of location features to generate a set of image features for the location. The operations further include completing, using the set of image features, ray casting to the target object and volume rendering to generate a feature image, generating a rendered image from the feature image, and processing the rendered image.

Other aspects of the invention will be apparent from the following description and the appended claims.

### BRIEF DESCRIPTION OF DRAWINGS

FIG. 1 shows a diagram of an autonomous training and testing system in accordance with one or more embodiments.

FIG. 2 shows a flowchart of the autonomous training and testing system in accordance with one or more embodiments.

FIG. 3 shows a diagram of a rendering system in accordance with one or more embodiments.

FIG. 4 shows an example architecture diagram of the rendering system in accordance with one or more embodiments.

FIG. 5 shows a flowchart for neural hash grid training in accordance with one or more embodiments.

FIG. 6 shows a flowchart for generating a virtual environment in accordance with one or more embodiments.

FIG. 7 shows an example of a neural hash grid-based environment in accordance with one or more embodiments.

FIGS. 8A and 8B show an example simulation scenario as modified from the real world in accordance with one or more embodiments.

FIGS. 9A and 9B show a computing system in accordance with one or more embodiments of the invention.

Like elements in the various figures are denoted by like reference numerals for consistency.

### DETAILED DESCRIPTION

In general, embodiments are directed to reconstructing the real world in the virtual world while allowing for some change during the reconstruction. For a particular object, a neural hash grid is defined that includes hash grid features for the object. In one or more embodiments, both stationary and moving objects may be represented by respective neural hash grids. The neural hash grid features describe the target object. Ray casting may be performed to render an image. When ray casting is performed, the ray may intercept a location in the target object. To render the portion of the target object at the location, the neural hash features adjacent to the location are interpolated to generate location features. The location features are processed through a multilayer perceptron model (MLP) model to generate an object's appearance for the location. The ray casting is completed using the object's appearance to generate a feature image. Namely, the collection of rays simulates the player's view in the real world such that the player should have the same input as if the player were in a real world (i.e., if the virtual world were real). The feature image may be further processed by a convolutional neural network (CNN) to generate the rendered image. For example, the CNN may perform upscaling and correct artifacts. The result is a more realistic virtual world.

In one or more embodiments, the processing by system may be used to generate a virtual world that mimics the real world, but with different scenarios implemented. For example, the changed scenarios may be that dynamic and/or static objects are in different locations, the perspective of the player is changed because the player is in a different location than the player was in the real world, or other aspects of the real world are different.

Embodiments of the invention may be used as part of generating a simulated environment for the training and testing of autonomous systems. An autonomous system is a self-driving mode of transportation that does not require a human pilot or human driver to move and react to the real-world environment. Rather, the autonomous system includes a virtual driver that is the decision-making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real-world environment is the portion of the real world through which the autonomous system, when trained, is designed to move. Thus, the real-world environment may include interactions with concrete and land, people, animals, other autonomous systems, human driven systems, construction, and other objects as the autonomous system moves from an origin to a destination. In order to interact with the real-world environment, the autonomous system includes various types of sensors, such as LiDAR sensors amongst other types, which are used to obtain measurements of the real-world environment, and cameras that capture images from the real-world environment.

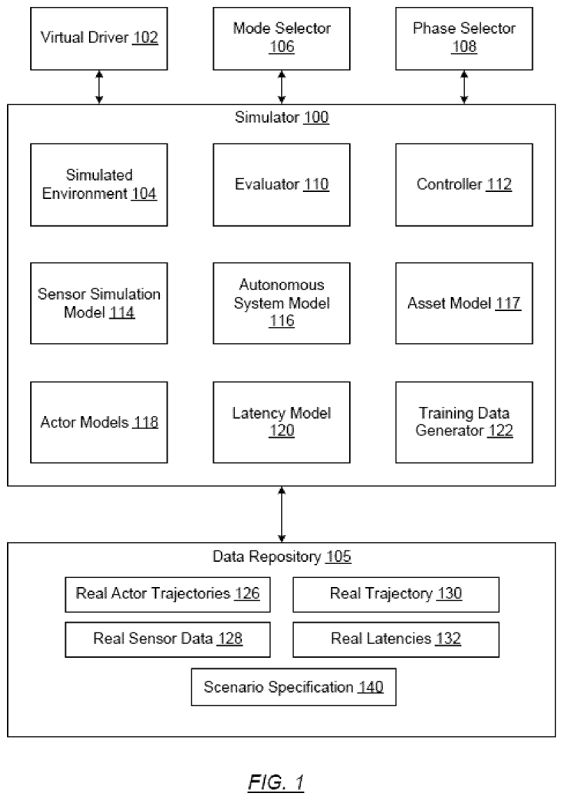

The testing and training of the virtual driver of the autonomous systems in the real-world environment is unsafe because of the accidents that an untrained virtual driver can cause. Thus, as shown in FIG. 1, a simulator (100) is configured to train and test a virtual driver (102) of an autonomous system. For example, the simulator may be a unified, modular, mixed-reality, closed-loop simulator for autonomous systems. The simulator (100) is a configurable simulation framework that enables not only evaluation of different autonomy components in isolation but also as a complete system in a closed-loop manner. The simulator reconstructs “digital twins” of real-world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) which is a virtual world. The virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and non-stationary objects. Non-stationary objects are actors in the real-world environment.

The simulator (100) also includes an evaluator (110). The evaluator (110) is configured to train and test the virtual driver (102) by creating various scenarios in the simulated environment. Each scenario is a configuration of the simulated environment including, but not limited to, static portions, movement of simulated objects, actions of the simulated objects with each other, and reactions to actions taken by the autonomous system and simulated objects. The evaluator (110) is further configured to evaluate the performance of the virtual driver using a variety of metrics.

The evaluator (110) assesses the performance of the virtual driver throughout the performance of the scenario. Assessing the performance may include applying rules. For example, the rules may be that the automated system does not collide with any other actor, compliance with safety and comfort standards (e.g., passengers not experiencing more than a certain acceleration force within the vehicle), the automated system not deviating from executed trajectory), or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of the success criterion for a particular scenario. Further, in addition to system level performance, for modular based virtual drivers, the evaluator may also evaluate individual modules such as segmentation or prediction performance for actors in the scene with respect to the ground truth recorded in the simulator.

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be a training phase or a testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, the degree of perturbations of real-world data, and whether the scenarios are designed to be adversarial. Example modes include open loop simulation mode, closed loop simulation mode, single module closed loop simulation mode, fuzzy mode, and adversarial mode. In an open loop simulation mode, the virtual driver is evaluated with real world data. In a single module closed loop simulation mode, a single module of the virtual driver is tested. An example of a single module closed loop simulation mode is a localizer closed loop simulation mode in which the simulator evaluates how the localizer estimated pose drifts over time as the scenario progresses in simulation. In a training data simulation mode, simulator is used to generate training data. In a closed loop evaluation mode, the virtual driver and simulation system are executed together to evaluate system performance. In the adversarial mode, the actors are modified to perform adversarial. In the fuzzy mode, noise is injected into the scenario (e.g., to replicate signal processing noise and other types of noise). Other modes may exist without departing from the scope of the system.

The simulator (100) includes the controller (112) which includes functionality to configure the various components of the simulator (100) according to the selected mode and phase. Namely, the controller (112) may modify the configuration of each of the components of the simulator based on the configuration parameters of the simulator (100). Such components include the evaluator (110), the simulated environment (104), an autonomous system model (116), sensor simulation models (114), asset models (117), actor models (118), latency models (120), and a training data generator (122).

The autonomous system model (116) is a detailed model of the autonomous system in which the virtual driver will execute. The autonomous system model (116) includes model, geometry, physical parameters (e.g., mass distribution, points of significance), engine parameters, sensor locations and type, the firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of the engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

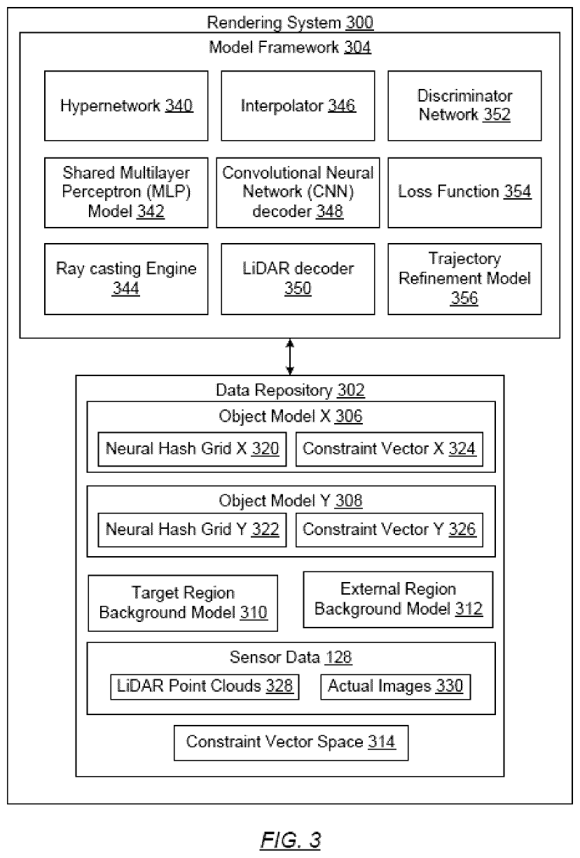

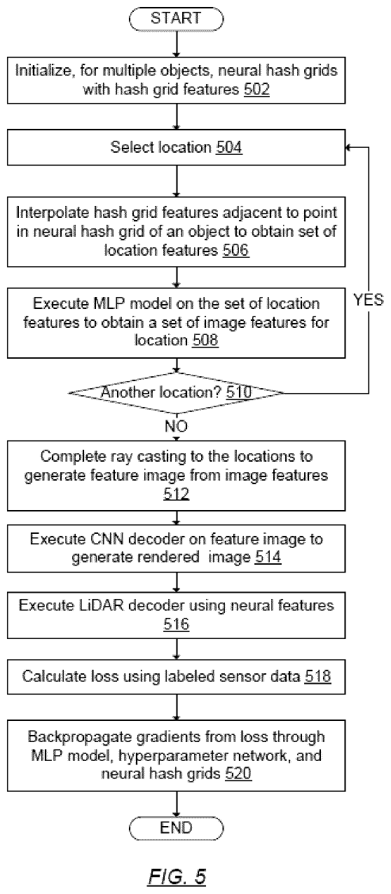

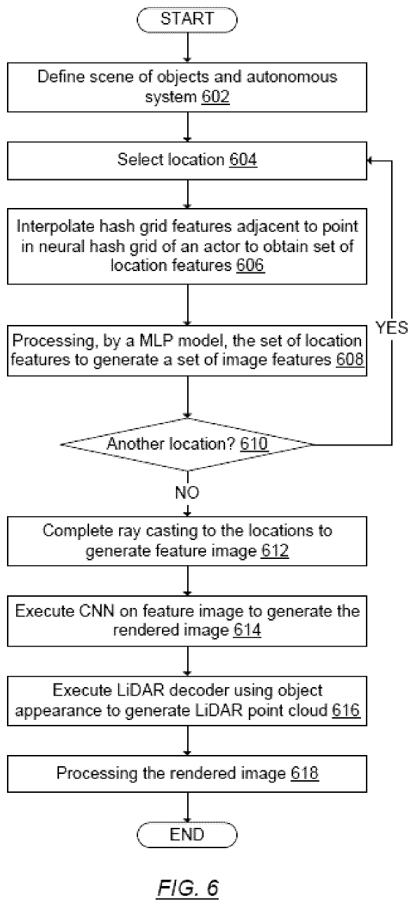

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment. By way of an example, the active sensor measurements may be measurements that a LiDAR sensor would make of the simulated environment over time and in relation to the movement of the autonomous system. In one or more embodiments, all or a portion of the sensor simulation models (114) may be or include the rendering system (300) shown in FIG. 3. In such a scenario, the rendering system of the sensor simulation models (114) may perform the operations of FIGS. 5 and 6.

The sensor simulation models (114) are configured to simulate the sensor observations of the surrounding scene in the simulated environment (104) at each time step according to the sensor configuration on the vehicle platform. When the simulated environment directly represents the real-world environment, without modification, the sensor output may be directly fed into the virtual driver. For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in the real world and use the same autonomous system as in the real world, the original sensor observations may be replayed at each time step.

Asset models (117) include multiple models, each model modeling a particular type of individual asset in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the objects or assets in the scenario. The assets can be composed together to form the three-dimensional simulated environment. An asset model provides all the information needed by the simulator to simulate the asset. The asset model provides the information used by the simulator to represent and simulate the asset in the simulated environment.

Closely related to, and possibly considered part of the set of asset models (117) are actor models (118). An actor model represents an actor in a scenario. An actor is a sentient being that has an independent decision-making process. Namely, in the real world, the actor may be animate being (e.g., a person or animal) that makes a decision based on an environment. The actor makes active movement rather than or in addition to passive movement. An actor model, or an instance of an actor model may exist for each actor in a scenario. The actor model is a model of the actor. If the actor is in a mode of transportation, then the actor model includes the model of transportation in which the actor is located. For example, actor models may represent pedestrians, children, vehicles being driven by drivers, pets, bicycles, and other types of actors.

The actor model leverages the scenario specification and assets to control all actors in the scene and their actions at each time step. The actor's behavior is modeled in a region of interest centered around the autonomous system. Depending on the scenario specification, the actor simulation will control the actors in the simulation to achieve the desired behavior. Actors can be controlled in various ways. One option is to leverage heuristic actor models, such as an intelligent-driver model (IDM) that try to maintain a certain relative distance or time-to-collision (TTC) from a lead actor or heuristic-derived lane-change actor models. Another is to directly replay actor trajectories from a real log or to control the actor(s) with a data-driven traffic model. Through the configurable design, embodiments may mix and match different subsets of actors to be controlled by different behavior models. For example, far-away actors that initially may not interact with the autonomous system and can follow a real log trajectory, but when near the vicinity of the autonomous system may switch to a data-driven actor model. In another example, actors may be controlled by a heuristic or data-driven actor model that still conforms to the high-level route in a real-log. This mixed-reality simulation provides control and realism.

Further, actor models may be configured to be in cooperative or adversarial mode. In cooperative mode, the actor model models actors to act rationally in response to the state of the simulated environment. In adversarial mode, the actor model may model actors acting irrationally, such as exhibiting road rage and bad driving.

In one or more embodiments, the actor models (118), asset models (117), and background may be part of the rendering system (described below with reference to FIG. 3). As another example, the system may be a bifurcated system whereby the operations (e.g., trajectories or positioning) of the assets and actors are defined separately from the appearance, which is part of the rendering system.

The latency model (120) represents timing latency that occurs when the autonomous system is in a real-world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. The latency model simulates the exact timings and latency of different components of the onboard system. To enable scalable evaluation without strict requirements on exact hardware, the latencies and timings of the different components of the autonomous system and sensor modules are modeled while running on different computer hardware. The latency model may replay latencies recorded from previously collected real world data or have a data-driven neural network that infers latencies at each time step to match the hardware in a loop simulation setup.

The training data generator (122) is configured to generate training data. For example, the training data generator (122) may modify real-world scenarios to create new scenarios. The modification of real-world scenarios is referred to as mixed reality. For example, mixed-reality simulation may involve adding in new actors with novel behaviors, changing the behavior of one or more of the actors from the real-world, and modifying the sensor data in that region while keeping the remainder of the sensor data the same as the original log. In some cases, the training data generator (122) converts a benign scenario into a safety-critical scenario.

The simulator (100) is connected to a data repository (105). The data repository (105) is any type of storage unit or device that is configured to store data. The data repository (105) includes data gathered from the real world. For example, the data gathered from the real world include real actor trajectories (126), real sensor data (128), real trajectories of the system capturing the real world (130), and real latencies (132). Each of the real actor trajectories (126), real sensor data (128), real trajectory of the system capturing the real world (130), and real latencies (132) is data captured by or calculated directly from one or more sensors from the real world (e.g., in a real-world log). In other words, the data gathered from the real-world are actual events that happened in real life. For example, in the case that the autonomous system is a vehicle, the real-world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of the autonomous system (e.g., the full 6D pose, velocity and acceleration), the map information specifying the road layout, and the scene layout specifying the initial state of all the dynamic actors and objects in the scenario. The scenario specification may also include dynamic actor information describing how the dynamic actors in the scenario should evolve over time which are inputs to the actor models. The dynamic actor information may include route information for the actors, desired behaviors or aggressiveness. The scenario specification (140) may be specified by a user, programmatically generated using a domain-specification-language (DSL), procedurally generated with heuristics from a data-driven algorithm, or adversarial-based generated. The scenario specification (140) can also be conditioned on data collected from a real-world log, such as taking place on a specific real-world map or having a subset of actors defined by their original locations and trajectories.

The interfaces between the virtual driver and the simulator match the interfaces between the virtual driver and the autonomous system in the real world. For example, the sensor simulation model (114) and the virtual driver match the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real-world setting.

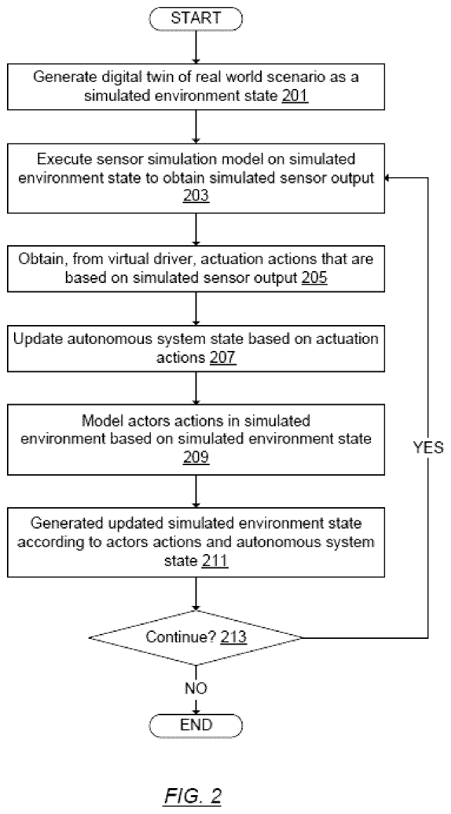

FIG. 2 shows a flow diagram for executing the simulator in a closed loop mode. In Block 201, a digital twin of a real-world scenario is generated as a simulated environment state. Log data from the real world is used to generate an initial virtual world. The log data defines which asset and actor models are used in the initial positioning of assets. For example, using convolutional neural networks on the log data, the various asset types within the real world may be identified. As other examples, offline perception systems and human annotations of log data may be used to identify asset types. Accordingly, corresponding asset and actor modes may be identified based on the asset types and add to the positions of the real actors and assets in the real world. Thus, the asset and actor models create an initial three-dimensional virtual world.

In Block 203, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver. In one or more embodiments, Block 203 may be performed as shown in FIGS. 5 and 6 (described below) to generate camera output and lidar sensor output, respectively, for a virtual camera and a virtual lidar sensor, respectively. The operations of FIGS. 5 and 6 may be performed for each camera and lidar sensor on the autonomous system to simulate the output of the corresponding camera and lidar sensor. Location and viewing direction of the sensor with respect to the autonomous vehicle may be used to replicate the originating location of the corresponding virtual sensor on the simulated autonomous system. Thus, the various sensor inputs to the virtual driver match the combination of inputs if the virtual driver were in the real world.

The simulated sensor output is passed to the virtual driver. In Block 205, the virtual drive executes based on the simulated sensor output to generate actuation actions. The actuation actions define how the virtual driver controls the autonomous system. For example, for an SDV, the actuation actions may be the amount of acceleration, movement of the steering, triggering of a turn signal, etc. From the actuation actions, the autonomous system state in the simulated environment is updated in Block 207. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snowy environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 209, actors actions in the simulated environment are modeled based on the simulated environment state. Concurrently with the virtual driver model, the actor models and asset models are executed on the simulated environment state to determine an update for each of the assets and actors in the simulated environment. Here, the actors' actions may use the previous output of the evaluator to test the virtual driver. For example, if the actor is adversarial, the evaluator may indicate based on the previous action of the virtual driver, the lowest scoring metric of the virtual driver. Using a mapping of metrics to actions of the actor model, the actor model executes to exploit or test that particular metric.

Thus, in Block 211, the simulated environment state is updated according to the actors' actions and the autonomous system state to generate an updated simulated environment state. The updated simulated environment includes the change in positions of the actors and the autonomous system. Because the models execute independently of the real world, the update may reflect a deviation from the real world. Thus, the autonomous system is tested with new scenarios. In Block 213, a determination is made whether to continue. If the determination is made to continue, testing of the autonomous system continues using the updated simulated environment state in Block 203. At each iteration, during training, the evaluator provides feedback to the virtual driver. Thus, the parameters of the virtual driver are updated to improve the performance of the virtual driver in a variety of scenarios. During testing, the evaluator is able to test using a variety of scenarios and patterns including edge cases that may be safety critical. Thus, one or more embodiments improve the virtual driver and increase the safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

FIG. 3 shows a diagram of the rendering system (300) in accordance with one or more embodiments. The rendering system (300) is a system configured to generate virtual sensor input using neural hash grids for objects. In particular, the rendering system (300) may be configured to render camera images and lidar images. The rendering system (300) includes a data repository (302) connected to a model framework (304). The data repository (302) includes sensor data (128), object models (e.g., object model X (306), object model Y (308)), a target region background model (310), an external region background model (312), and a constraint vector space (314).

The sensor data (128) is the sensor data described above with reference to FIG. 1. The sensor data (128) includes LiDAR point clouds (328) and actual images (330). LiDAR point clouds (328) are point clouds captured by LiDAR sensors performing a LiDAR sweep of a geographic region. Actual images (330) are images captured by one or more cameras of the geographic region. For example, as a sensing vehicle is moving through a geographic region the sensing vehicle may have cameras and LiDAR sensors that gather sensor data from the geographic region. Notably, the sensor data (128) is the time series of data that is captured along the trajectory of the sensing vehicle. As such, the sensor data (128) generally omits several side views of three-dimensional objects. Thus, a challenge exists when performing closed loop simulation to generate a three-dimensional object model (e.g., object model X (306), object model Y (308)) of an object when several of the views of the object do not exist. For example, for many objects, certain sides of the objects may not have any sensor data, and other sides may only have sensor data from a perspective view (e.g., a perspective of the corner). By way of a more specific example, consider a sensing vehicle moving along a street. Cameras on the sensing vehicle can capture directly, the sides of other vehicles that are parked along the street as well as a small amount of the front and back of the parked vehicles that are not hidden. The camera may also capture images of another vehicle being driven in front of the sensing vehicle. When the other vehicle turns, the camera may capture a different side but does not capture the front. As such, the sensor data (128) is imperfect as it does not capture the three-hundred-and-sixty-degree view of the objects.

The object models (e.g., object model X (306), object model Y (308)) are three-dimensional object models of objects. The object models (e.g., object model X (306), object model Y (308)) each include a neural hash grid (e.g., neural hash grid X (320), neural hash grid Y (322)) and a constraint vector (e.g., constraint vector X (324), constraint vector Y (326)).

A neural hash grid (e.g., neural hash grid X (320), neural hash grid Y (322)) is a grid of neural network features generated for a corresponding object. Each location has a corresponding location in the neural hash grid, whereby the relative locations between two locations on the object match the relative locations of matching points in the neural hash grid. Stated another way, the neural hash grid is a scaled model of the object, whereby corresponding points have learned features from the object. In one or more embodiments, the neural hash grid has a hierarchy of resolutions. The hierarchy of resolutions may be defined by representing the model of the object as cubes containing sub-cubes. For example, at the lowest resolution, the object is represented by a first set of cubes, each cube having features defined for the entire cube. Each cube in the first set of cubes may be partitioned into sub-cubes (e.g., such as 9 sub-cubes). A sub-cube is a cube that is wholly contained in another cube. Each sub-cube has a set of features for the particular sub-cube that are features defined for the matching location in the object. Sub-cubes may each further be partitioned into sub-cubes, with a corresponding set of features defined, and the process may repeat to the lowest resolution. Each cube, regardless of the resolution, has a corresponding region on the object. By way of an example of a vehicle, at a first resolution, the vehicle may include individual cubes for each of the front, middle, and back of the vehicle. The cube for the middle region may include individual sub-cubes for the portions of the vehicle having the left side front door, the left side front window, the left side back door, and the left side back window, without specifically identifying or demarcating the doors, windows, handles, etc. The neural hash grid (e.g., neural hash grid X (320), neural hash grid Y (322)) is a feature grid learned from the real sensor data (128) and, as such, may not include direct attributes of color, luminosity, etc., but rather encoded features learned through machine learning.

The constraint vector (e.g., constraint vector X (324), constraint vector Y (326)) is a vector specific to the object model that is learned from multiple objects. The constraint vector serves to constrain the features of the object model. The constraint vector is defined by the constraint vector space (314). The constraint vector space is a shared representation of objects. Namely, the constraint vector space is learned from multiple objects and allows for cross usage of information between objects. By way of an example, the constraint vector space allows for a missing view from one object to be learned from the views of other objects. However, the objects may not be identical, and therefore not have identical features. For example, a red sportscar front cannot be copied onto a blue SUV and be accurate. Thus, the missing view is not a direct copy but rather learned from the combination of views of the other objects and its own features. As such, the constraint vector for an object as generated by the constraint vector space is an object prior that is used to generate the object model.

Continuing with FIG. 3, the target region background model (310) and the external region background models (312) defines different types of backgrounds. The target region background has the background objects that are within the region of interest (i.e., the target region) of the autonomous system. For example, the region of interest may be within one hundred and fifty meters in front of the autonomous system, forty meters behind the autonomous system, and twenty meters on each side of the autonomous system. The target region background model (310) may represent the entire target region as described above with reference to the object models. However, in the target region background model, rather than representing individual objects, the whole target region or specific sub-regions thereof may be captured in the same model.

The external region background model (312) is a background model of anything outside of the target region. Outside of or external to refers to locations that are geographically farther than the current target region. In the above example, the external region is the region farther than one hundred and fifty meters in front of the autonomous system, forty meters behind the autonomous system, and twenty meters on each side of the autonomous system. For the external region background model (312), the region may be represented through an inverted sphere. Spherical projections or optimizations may be used as the external region background model.

The model framework (304) is configured to generate the object models and perform the neural hash grid sensor simulation. The model framework (304) includes a hypernetwork (340), a shared multi-layer perceptron model (342), a ray casting engine (344), an interpolator (346), a convolutional neural network (CNN) decoder (348), a LiDAR decoder (350), a discriminator network (352), a loss function (354), and a trajectory refinement model (356).

The hypernetwork (340) is an MLP network configured to generate the actor neural hash grids representation from the constraint vector space (314). In one or more embodiments, the hypernetwork (340) is learned across the object models.

The shared MLP model (342) is an MLP model that is configured to generate geometric and appearance features from the object models. Generally, an MLP model is a feedforward artificial neural network having at least three layers of nodes. The layers include an input layer, a hidden layer, and an output layer. Each layer has multiple nodes. Each node includes an activation function with learnable parameters. Through training and backpropagation of losses, the parameters are updated and correspondingly, the MLP model improves in making predictions.

Although a single shared MLP model (342) is shown, the MLP model may include multiple MLP models. An MLP geometry model maps a point location to signed distance and then to a volume density. The MLP surface model is trained based on sensor data. The signed distance function of the NeRSDF model maps a location in three-dimensional space to the location's signed distance from the object's surface (i.e., object surface). The signed distance is a distance that may be positive, zero, or negative from the target object surface depending on the position of the location with respect to the object surface. In the signed distance, a positive value is outside the first surface of the object that the ray passes through, zero at object surface, negative inside the object, most negative at center of the object, and less negative closer to second surface of the object, zero at second surface of the object that the ray passes through, and then positive outside the second surface that the object passes through. The signed distance may then be mapped by a position function that maps the signed distance to one if the location is inside the object and zero otherwise.

A second MLP may be a feature descriptor MLP. The second MLP may take, as input, the geometry feature vector and viewpoint encoding and predict a neural feature descriptor. The neural feature descriptor includes neural features for the particular point. In one or more embodiments, the second MLP is a single MLP that takes the location and view direction as input and directly outputs neural features descriptors.

A ray casting engine (344) is configured to define and cast rays to a target object from a sensor. For an object, the ray has a first endpoint at the virtual sensor and a second endpoint on an opposing side of the target object or where the ray intersects the target object. The ray may pass through the target object. As such, the ray passes through at least a near point on the surface of the target object and a far point on the surface of the target object. Because the ray is a line, an infinite number of locations are along the ray. One or more embodiments use a sampling technique to sample locations along the ray and determine feature descriptors for each location using the rest of the model framework (304). In one or more embodiments, the ray casting engine (344) is configured to aggregate the feature descriptors along the locations of the ray. A single ray may pass through multiple objects. Thus, the accumulation may be through the multiple objects.

The interpolator (346) is configured to interpolate features from the object model across different ones of the multiple resolutions and from different locations. Specifically, the interpolator (346) is configured to generate an interpolated set of features for a particular location in the object model from the neural hash grid.

The CNN decoder (348) is a convolutional neural network. The CNN decoder is configured to decode the output of the shared MLP model (342) to generate a color value for the particular sample location along the ray. In one or more embodiments, the CNN decoder (348) takes, as input, the neural feature descriptor of the particular location and generates, as output, a color value (e.g., red green blue (RGB) value) for the particular location. The CNN decoder (348) may be configured to upscale the output of the shared MLP model (342). As another example, the CNN decoder may be configured to remove artifacts from the original image.

The LiDAR decoder (350) is a neural network that is configured to generate a LiDAR point based on the output of the shared MLP model (342). The LiDAR point has a pair of depth and intensity that is accumulated along a LiDAR ray. The depth value for the LiDAR ray is calculated as the accumulation of the depths. An accumulation depth function may be used to calculate the depth value. The accumulation depth function weighs the depth values according to the position of the location and the accumulated transmittance. A decoder MLP model of the LiDAR decoder (350) takes, as input, the accumulated volume rendered features and outputs the intensity.

In one or more embodiments, the discriminator network (352) is a classifier model that is configured to train the CNN decoder. The discriminator network (352) is the discriminator portion of a generative adversarial network. The discriminator network (352) receives as input simulated images produced using the ray-casting engine and the CNN decoder (348) and actual images (330). The discriminator network (352) attempts to classify the simulated images and the actual images as either simulated or actual. If the discriminator network is correct in classifying the simulated images (i.e., the discriminator network correctly classifies a simulated image as simulated), then the classification contributes to a loss for updating the CNN decoder (348). If the discriminator network is incorrect in classifying the simulated images and actual images (i.e., the discriminator network incorrectly correctly classifies a simulated image as actual or vice versa), then the classification contributes to a loss for updating the discriminator network (352). Thus, the discriminator network (352) is adversarial to the CNN decoder (348) whereby the classification leads to a loss for one of the two networks.

The loss function (354) is a function used to calculate the loss for the system. The loss function (354) uses the various outputs of the model framework (304) to calculate a loss that is used to update, through backpropagation, the model framework (304). During the backpropagation, one or more layers may be frozen to calculate the loss of the other layers.

The trajectory refinement model (356) is a model configured to refine the object trajectory to make sure the trajectories of objects are more accurate. This model may optimize the six degrees of freedom (DoF) pose of the object at each timestamp to minimize the loss function and more accurately reflect the object locations.

In one or more embodiments, the trajectory refinement model uses the prior images and LiDAR data to refine the trajectory.

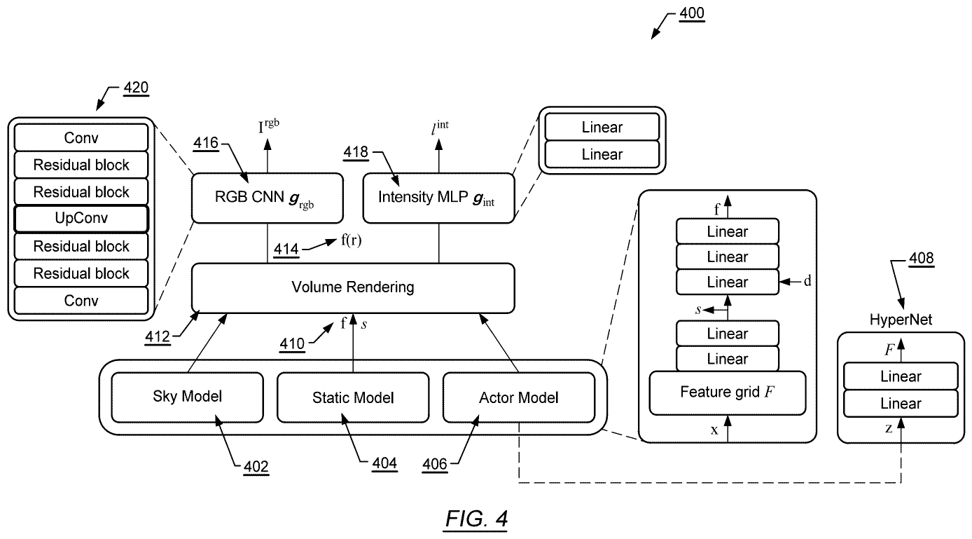

Turning to FIG. 4, FIG. 4 shows an implementation (400) of the rendering system (300) shown in FIG. 3. Specifically, FIG. 4 shows an example architecture diagram of the rendering system in accordance with one or more embodiments.

As shown in FIG. 4, the scene is divided into three components: static scene (404), distant region (e.g., sky) (402), and dynamic actors (406). The actors are the objects described above. The three components of the scene are modeled using the same architecture but with different feature grid size. For each dynamic actor, its feature grid F is generated by the hypernetwork (HyperNet) from the latent code z. First, for each sampled point along the ray r with location x and view direction d, the feature descriptor f (410) is queried from the neural hash grid. Then, volume rendering (412) is performed to get the rendered feature descriptor f (414). A CNN decoder (416) is used to decode the feature descriptor patch to an RGB image (418), and a LiDAR intensity MLP decoder (420) is used to predict the LiDAR intensity lᵢₙₜ for ray r. The various portions correspond to like named components in FIG. 3.

After the neural hash grids are constructed, one or more embodiments retrieve the features for each sampled point via tri-linear interpolation and apply a small MLP to generate an intermediate feature. The view direction is then concatenated with the feature before sending the concatenated view direction-feature to the final linear layers. A convolutional neural network g_{rgb} (416) is applied on top of the rendered feature map and produces the final image. One or more embodiments also have an additional decoder for lidar intensity (gᵢₙₜ) (418). Each of the components is described in further detail below.

The following is a description of scene representation. One or more embodiments first define the region of interest using the SDV trajectory. One or more embodiments then generate an occupancy grid for the volume and set the voxel size. For the static scene model, the multi-resolution feature grids may have sixteen levels in the resolution hierarchy. The resolution may increase exponentially. For the dynamic actor model, the multi-resolution feature grids may have several levels and the resolution increases exponentially. A spatial hash function may be used to map each feature grid to a fixed number of features.

The following is a description of the dynamic actor model (i.e., the neural hash grid in FIG. 3). Each actor model is represented by an independent features grid generated from a shared HyperNet (408). The HyperNet fz is a multi-layer MLP. The dynamic actor tracklets that are provided might be inaccurate, even when human-annotated, and lead to blurry results. Thus, the actor tracklets may be refined during training. For each dynamic actor Aᵢ with trajectory initialized by a sequence of poses, one or more embodiments jointly optimize the rotation and translation components of the poses at each timestep. A symmetry prior along the longitudinal axis may be incorporated for vehicle objects. During training, one or more embodiments randomly flip the input point and view direction when querying the neural feature fields.

The following is a description of the sky model (i.e., external region background model in FIG. 3). For distant regions outside the volume, one or more embodiments modeled the distant regions using an inverted sphere parameterization. One or more embodiments sample sixteen points for the distant sky region during volume rendering.

Neural feature fields NFFs may be obtained as follows. To obtain the geometry s and feature descriptor f from the features grid for both the static scene (f_{bg}) and actors (f_{A}), both f_{bg} and fA include multiple sub-networks. A first sub-network may be an MLP that takes the interpolated feature and predicts the geometry s (signed distance value) and intermediate geometry feature. The second sub-network may be an MLP that takes the intermediate geometry feature and viewpoint encoding as input and predicts the neural feature descriptor f.

The following is a description of the CNN decoder (e.g., a camera RGB decoder). As shown in the expanded section (420) of FIG. 4, the camera RGB decoder may have multiple residual blocks. A convolution layer is applied at the beginning to convert an input feature to a first set of channels, and another convolution layer is applied to predict the final output image. An up-sample layer may be between the different residual blocks of the CNN.

To improve photorealism at un-observed viewpoints, one or more embodiments render the image at new camera viewpoints during training. To create the “pseudo” camera poses, one or more embodiments randomly jitter the translation components of the training camera poses with standard Gaussian noise. As ground truth supervision is not available in the new views, one or more embodiments may apply adversarial training to enforce the rendered image patches to look similar to the unperturbed pose image patches.

The LiDAR intensity decoder gᵢₙₜ may be a multi-layer MLP.

Training may be performed as follows. One or more embodiments may have multi-stage training to speed up convergence and for better stability. In the first stage, the CNN decoder is frozen, and only the NFFs are trained for multiple iterations. In the second stage, one or more embodiments train the CNN and the NFFs jointly for multiple iterations. In the last stage, one or more embodiments add an adversarial loss on the jitter pose for multiple iterations. In the stages, one or more embodiments sample multiple LiDAR rays per iteration plus camera rays.

FIGS. 5 and 6 show flowcharts in accordance with one or more embodiments. FIG. 5 shows a flowchart for training the rendering system and FIG. 6 shows a flowchart for using the rendering system. While the various steps in these flowcharts are presented and described sequentially, at least some of the steps may be executed in different orders, may be combined or omitted, and at least some of the steps may be executed in parallel. Furthermore, the steps may be performed actively or passively.

In Block 502, for multiple objects including stationary and moving objects, the neural hash grids are initialized. Further, the constraint vectors may be initially set to zero. To initialize the neural hash grid, the hypernetwork takes the constraint vector for each moving object and directly predicts the neural hash grid within the volume of the object's bounding box. The background scene (e.g., the target region and the external region) does not have a hypernetwork, and one or more embodiments directly learn the target region background model and the external region background model.

In Block 504, a location is selected. For a particular virtual sensor, a set of rays is defined based on the sensor's intrinsics and extrinsics. Because the virtual sensor may replicate a real sensor on a real autonomous system, the virtual sensor's intrinsics and extrinsics may be defined by a corresponding real sensor. The ray casting engine casts rays into the scene (e.g., defined by the simulation system). During training, the scene is set as a scene in the real world. Thus, real camera and LiDAR images may match the virtual scene that is being rendered. For each ray, points along the ray are sampled. Each sampled point corresponds to a location that may be selected in Block 504.

In Block 506, hash grid features adjacent to the sampled point in the corresponding neural hash grid of an object are interpolated to obtain a set of location features. Trilinear interpolation may be performed. Specifically, for a particular location, the object at the location is identified and the neural hash grid for the object is obtained. The cubes of the neural hash grid in which the location is located at each resolution are determined. Interpolation is applied to the cubes to calculate the specific location features at that specific location in continuous space.

In Block 508, the MLP model is executed on the set of location features to obtain a set of image features for the location. In one or more embodiments, the MLP model is a shared MLP model that generates neural features (i.e., image features) from the set of location features. The locations features are processed as a feature vector through the layers of the MLP model to generate the neural features. The neural feature may be further processed through volume rendering to generate the image feature map. One or more embodiments volume render an image feature map. The feature map is processed by the CNN decoder to generate the final image. The image features in the feature map are different from the hash grid features. The image feature is generated by the shared MLP that takes the hash grid feature and view direction as input. Equation (1) below characterizes the generation of the image features in one or more embodiments.

In Block 510, a determination is made whether another location exists. If another location exists, the flow returns to Block 504 to select the next location. For example, the next ray or the next sample along the ray may be determined.

In Block 512, ray casting is performed to generate a feature image from the image features. The ray casting engine combines the features from the feature map along the ray to generate accumulated features for the ray. The process is repeated for each ray by the ray casting engine.

In Block 514, a CNN decoder model is executed on the feature image to generate a rendered image. The CNN has a first layer that takes the feature image as input. Through processing by the multiple layers, the CNN upscales the feature image and corrects artifacts. The result is an output image.

In Block 516, a LiDAR decoder is executed on the output of the MLP model. In one or more embodiments, because LiDAR sensors may be located at different locations than the cameras on an autonomous system, although the same models may be used for LiDAR and camera, different outputs of the MLP model may be used for the LiDAR and camera. A LiDAR point has a distance value and an intensity value. The distance value may be calculated directly from the sample points along the ray. The LiDAR decoder model may predict the intensity value from the outputs of the sample points along the ray.

In Block 518, a loss is calculated using the labeled sensor data. In one or more embodiments a single loss value is calculated as a combination of losses. The single loss is backpropagated through the models of the network. Loss is determined using observed values acquired from the real world. For example, a sensing vehicle driving down a street may have cameras and lidar sensors to capture various observations of the target object. The loss includes RGB pixel loss LiDAR loss, a regularization loss, and adversarial loss.

RGB loss is a camera image loss accumulated across patches using color values in the rendered image and sensor data for the same viewing direction and angle. For each of at least a subset of pixels, the observed color value for the corresponding pixel in the target image is determined. Specifically, the difference between the observed color value and the simulated color value is calculated. The averages of the differences are the camera image loss.

The cameral image loss may also a perceptual loss. A perceptual loss may use a pretrained network that computes a feature map from an image. The difference between the feature map generated by the pretrained network on the actual image and the feature map generated by the pretrained network on the rendered image is the perceptual loss.

An adversarial loss may be calculated based on whether the pre-trained discriminator correctly classified the rendered image as a simulated image or as a real image. As described above with reference to FIG. 3, the output of the classification may contribute to the camera image loss or may contribute to a discriminator loss to further train the discriminator network.

The LiDAR loss is a loss accumulated across a subset of lidar rays and may be calculated using lidar points determined for the lidar rays and sensor data for the same viewing direction and angle as the lidar ray. For each lidar ray, the observed lidar point for the target object at the same viewing direction and angle as the lidar ray is obtained. The observed lidar point is compared to the simulated LiDAR depth. Specifically, the difference between the depths in the observed lidar point value and the simulated depth in the simulated lidar point value is calculated as the depth difference. Similarly, the difference between the intensities in the observed lidar point value and the simulated intensity in the simulated lidar point value is calculated as the intensity difference. The depth difference and intensity difference are combined, such as through weighted summation to generate a total difference for the lidar point. Averages of the total differences across the lidar points is the lidar loss.

In at least some embodiments, a regularization term is calculated and used as part of the total loss. The regularization term may include a term to encourage the signed distance function to satisfy the Eikonal equation and a smoothness term to encourage the reconstructed target object to be smooth.

The total loss may be calculated as a weighted summation of the losses. Each loss is weighted by a parameter for weighing the loss. The parameters are configurable.

The total loss is backpropagated through the models of the rendering system. During different time periods of the training, different models may be frozen to calculate the total loss. Specifically, the total loss is backpropagated through the MLP, LiDAR, CNN, and hypernetwork. The process may repetitively train the model framework to iteratively improve the rendering system.

FIG. 6 shows a flowchart for using the trained neural hash grids to render a scene in accordance with one or more embodiments. In Block 602, a scene of objects and the autonomous system is defined. The scene may be defined based on a predefined scenario. For example, the simulation system may define a scenario to test the autonomous system. As another example, a predefined scenario may exist. As another example, the system may perturb an existing scenario by moving the player or objects in the scene to generate the scenario. Defining the scene specifies the location of the three-dimensional virtual objects and the autonomous system, or more generally, the player, in the virtual environment. As another example, based on a prior interaction, the virtual environment may be defined. Various mechanisms may be used to define the scene.

In Block 604, a location is selected. In Block 606, the hash grid features adjacent to the sampled point in the corresponding neural hash grid of an object are interpolated to obtain a set of location features. In Block 608, the MLP model is executed on the set of location features to obtain a set of image features for the location. In Block 610, a determination is made whether another location exists. If another location exists, the flow returns to Block 604 to select the next location. In Block 612, ray casting is completed to generate a feature image. In Block 614, a CNN decoder model is executed on the feature image to generate a rendered image. In Block 616, a LiDAR decoder is executed on the output of the MLP model. The processing of Blocks 604-616 may be performed identically during training as during use, but for a different scenario. The processing may be repeated for each iteration of the simulation. For example, the process may be repeated for each execution of Block 203 of FIG. 2. Because a trained rendering system is used, the output is a realistic representation of the simulated environment, but with objects in different positions than the real world.

In Block 618, the rendered image is processed. Processing the rendered image may include transmitting the rendered image to a different machine for display, displaying the rendered image, processing the rendered image by a virtual driver (e.g., to determine an action or reaction based on the rendered image), storing the rendered image, or performing other processing.

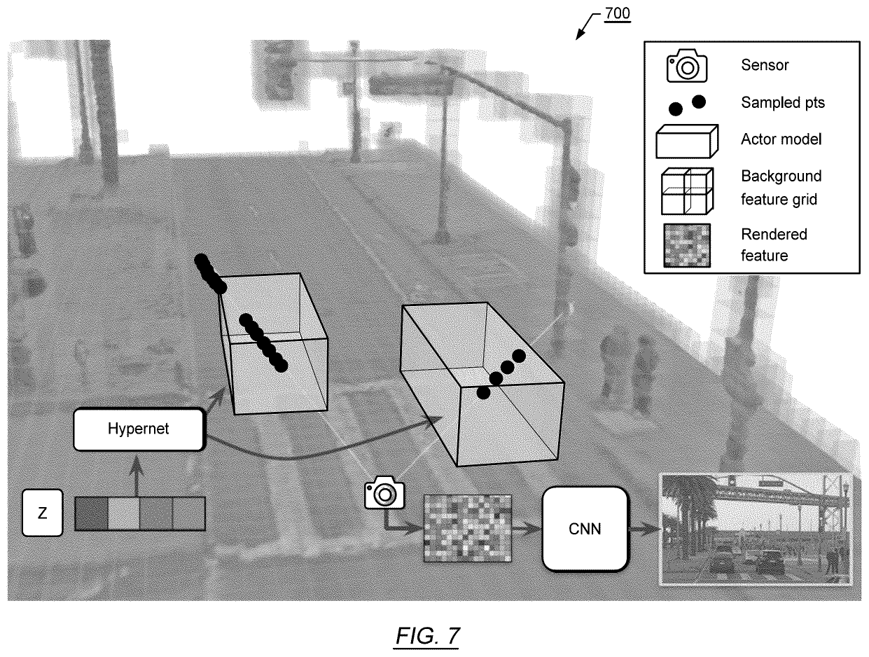

FIG. 7 shows an example of a three-dimensional scene (700) with the neural hash grids overlaid on the geographical region. As shown in FIG. 7, the 3D scene is decomposed into a static background (grey) and a set of dynamic actors (the images on the road). The neural hash grids are queried separately for static background and dynamic actor models. Volume rendering is performed to generate neural feature descriptors. The static scene is modeled with a sparse feature-grid. A hypernetwork is used to generate the representation of each actor from a learnable latent. Finally, the CNN is used to decode feature patches into an image.

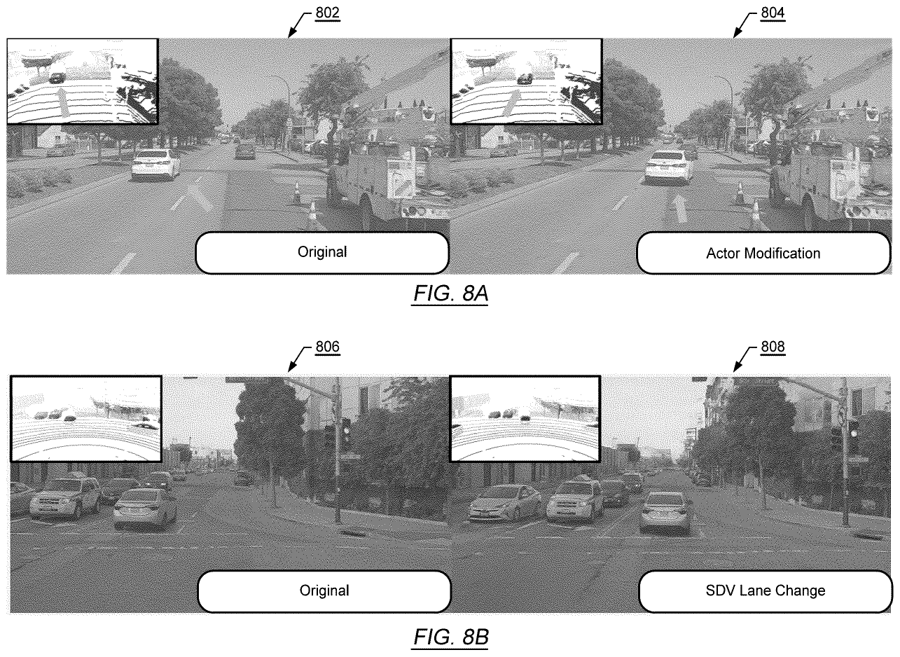

One or more embodiments may be used to create realistic sensor input for a mixed reality. For example, as shown in FIG. 8A and FIG. 8B, the simulator can create a mixed reality world in which actor actions deviate from the real world. In FIG. 8A, the left image (802) shows the real-world image captured through an actual camera on the autonomous system. The right image (804) of FIG. 8A shows the mixed reality image which deviates from the actual events. Namely, in the right image (804), the actor is shown as moving to a different lane. As shown, the image captures the actor even when variations exist in the viewing direction of the actor.

FIG. 8B shows a different deviation. Like FIG. 8A, the left image (806) shows the real-world image captured through an actual camera on the autonomous system while the right image (808) shows the mixed reality image which deviates from the actual events. In FIG. 8B, the self-driving vehicle (SDV) switches lanes. Thus, the viewing direction of all objects changes in the image. The deviation means that portions of the objects in the original image that were hidden are now shown in the simulated image. One or more embodiments adapt to the change through the three-dimensional object models so as to create realistic images of the real world. Using embodiments of the present disclosure, camera images and LiDAR point clouds from the simulated mixed reality simulation is indistinguishable from the real camera images and LiDAR point clouds. Thus, embodiments create more realistic sensor input at the virtual sensors.

Rigorously testing autonomy systems is performed for making safe self-driving vehicles (SDV) a reality. The testing generates safety critical scenarios beyond what can be collected safely in the world, as many scenarios happen rarely on public roads. To accurately evaluate performance, one or more embodiments need to test the SDV on these scenarios in a closed-loop, where the SDV and other actors interact with each other at each timestep. Previously recorded driving logs provide a rich resource from which to build these new scenarios, but for closed loop evaluation, one or more embodiments need to modify the sensor data based on the new scene configuration and the SDV's decisions, as actors might be added or removed and the trajectories of existing actors and the SDV will differ from the original log. One or more embodiments are directed to a neural sensor simulator that takes a single recorded log captured by a sensor-equipped vehicle and converts it into a realistic closed-loop multi-sensor simulation. Neural feature grids are generated to reconstruct both the static background and dynamic actors in the scene and composites them together to simulate LiDAR and camera data at new viewpoints, with actors added or removed and at new placements. To better handle extrapolated views, one or more embodiments incorporate learnable priors for dynamic objects, and leverage a convolutional network to complete unseen regions. A result is realistic sensor data with a small domain gap on downstream tasks.

Given a log with camera images and LiDAR point clouds captured by a moving platform, as well as their relative poses in a reference frame, a goal is to construct an editable and controllable digital twin, from which one or more embodiments can generate realistic multi-modal sensor simulation and counterfactual scenarios of interest. One or more embodiments build the model based on the intuition that the 3D world can be decomposed as a static background and a set of moving actors. By effectively disentangling and modeling each component, one or more embodiments can manipulate the actors to generate new scenarios and simulate the sensor observations from new viewpoints.

A feature field (i.e., neural feature field (NFF)) refers to a continuous function ƒ that maps a 3D point x∈ [symbol] ³ and a view direction d∈ [symbol] ² to an implicit geometry s∈ [symbol] and a N_{ƒ}-dimensional feature descriptor f∈ [symbol] ^{N}^{_{ƒ}}. Since the function is often parameterized as a neural network ƒ_{θ}: [symbol] ³× [symbol] ²→ [symbol] × [symbol] ^{N}^{_{ƒ}}, with θ the learnable weights, the feature field is a neural feature field (NFF). If the feature field represents the implicit geometry as volume density s∈ [symbol] ⁺ and the feature descriptor as RGB radiance f∈ [symbol] ³, NFFs is a NeRFs. If the implicit geometry is enforced to be the probability of occupancy, NFFs become occupancy functions. The NFF is parameterized by the feature grid, and given a input query point x, one or more embodiments obtain the NFF feature by tri-linearly interpolating the feature grid.

To improve the expressiveness and speed of NFFs, a learnable multi-resolution features grid

$${\{ {𝒢}^{l} \}}_{l = 1}^{L}$$

is combined with a neural network ƒ. Specifically, given a query point x∈ [symbol] ³, the 3D feature grid at each level is first trilinearly interpolated. The interpolated features are then concatenated with the view direction d∈ [symbol] ², and the resulting features are processed with an MLP head to obtain the geometry s and feature descriptor f:

$$s , f = f ( {\{ interp ( x , {𝒢}^{l} ) \}}_{l = 1}^{L} , d ) . \qquad ( 1 )$$

These multi-scale features encode both global context and fine-grained details, providing richer information as compared to the original input x. This also enables using a smaller ƒ, which significantly reduces the inference time. In one or more embodiments, the features are optimized using a fixed number of features [symbol] , and the features grid

$${\{ {𝒢}^{l} \}}_{l = 1}^{L}$$

mapped to [symbol] with a grid index hash function. Hereafter, [symbol] and

$${\{ {𝒢}^{l} \}}_{l = 1}^{L}$$

are used interchangeably.

One or more embodiments aim to build a compositional scene representation that best models the 3D world including the dynamic actors and static scene. Given a recorded log captured by a data collection platform, a 3D space volume is first defined over the traversed region. The volume includes a static background [symbol] and a set of dynamic actors

$${\{ {𝒜}_{i} \}}_{i = 1}^{N} .$$

Each dynamic actor is parameterized as a bounding box of dimensions [symbol] ∈ [symbol] ³, and the dynamic actor's trajectory is defined by a sequence of SE(3) poses

$${\{ {T}_{{𝒜}_{i}}^{t} \}}_{t = 1}^{T} .$$

The static background and dynamic actors are specified with separate multi-resolution features grids and NFFs. The static background is expressed in the world frame. One or more embodiments represent each actor in the actor's object-centroid coordinate system (defined at the centroid of the actor's bounding box) and transform the actor's features grid to world coordinates to compose with the background. This allows us to disentangle the 3D motion of each actor, and focus on representing shape and appearance. To learn the high-quality geometry, one or more embodiments adopt the signed distance function (SDF) as our implicit geometry representation s.

One or more embodiments model the whole static scene with a multi-resolution features grid [symbol] _{bg} and an MLP head ƒ_{bg}. Since a self-driving log often spans hundreds to thousands of meters, it is computationally and memory expensive to maintain a dense, high-resolution voxel grid. One or more embodiments thus utilize geometry priors from LiDAR observations to identify near-surface voxels and optimize only their features. Specifically, one or more embodiments first aggregate the static LiDAR point cloud from each frame to construct a dense 3D scene point cloud. One or more embodiments then voxelize the scene point cloud and obtain a scene occupancy grid V_{occ}. Finally, one or more embodiments apply morphological dilation to the occupancy grid and coarsely split the 3D space into free near-surface space. As the static background is often dominated by free space, this can significantly sparsify the features grid and reduce the computation cost. The geometry prior also allows us to better model the 3D structure of the scene, which is critical when simulating novel viewpoints with large extrapolation. To model distant regions, such as sky, the background scene model is extended to unbounded scenes.

Each actor [symbol] ᵢ is parameterized with a features grid [symbol] and a shared MLP head [symbol] is used for all actors. In this design, the individual features grid encodes instance-specific geometry and appearance, while the shared network maps them to the same feature space for downstream applications. To overcome limitations such as large memory for dense traffic scenes and needing to generalize to unseen viewpoints, one or more embodiments learn a hypernetwork over the parameters of the feature grids. The intuition is that different actors are observed from different viewpoints, and thus their grids of features are informative in different regions. By learning a prior the actors, one or more embodiments can capture the correlations between the features and infer the invisible parts from the visible ones. Specifically, one or more embodiments model each actor [symbol] ᵢ with a low-dimensional latent code [symbol] and learn a hypernetwork ƒ_{z} to regress the features grid [symbol] :

[symbol]

=ƒ_{z}( [symbol] ). (2)

Similar to the background, one or more embodiments adopt a shared MLP head ƒ_{A} to predict the geometry and feature descriptor at each sampled 3D point via Eq. 1. One or more embodiments jointly optimize the actor latent codes {z_{A}_{ᵢ}} during training.

One or more embodiments first transform the object-centric neural feature fields of the foreground actors to world coordinates with the desired poses, using

$${T}_{{𝒜}_{i}}^{t}$$

for reconstruction. Because static background is a sparse features grid, the free space is replaced with the actor feature fields. Through this operation, one or more embodiments can insert, remove, and manipulate the actors within the scene.

After composing a scene representation of the static and dynamic world, the next step is to render the scene into the data modality of interest. For the following, camera images and LiDAR point clouds are described. However, other decoders may be applied without departing from the scope of the claims.

For camera simulation, the following operations may be performed. One or more embodiments adopt a hybrid volume and neural rendering framework for efficient photorealistic image simulation. Given a ray r(t)=o+td shooting from the camera center o through the pixel center in direction d, one or more embodiments first sample a set of 3D points along the ray and extract their features and geometry (Eq. 1). One or more embodiments then aggregate the samples and obtain a pixel-wise feature descriptor via volume rendering:

$$f ( r ) = {\sum }_{i = 1}^{{N}_{r}} {w}_{i} {f}_{i} , {w}_{i} = {α}_{i} {\prod }_{j = 1}^{i - 1} ( 1 - {α}_{j} ) . \qquad ( 3 )$$

In equation (3), αᵢ∈[0,1] represents opacity, which one or more embodiments can derive from the SDF sᵢ using an approximate step function α=1/(1+exp(β·s)), and β is the hyper-parameter controlling the slope. One or more embodiments volume render the camera rays and generate a 2D feature map F∈ [symbol] ^{H}^{_{ƒ}}^{×W}^{_{ƒ}}^{×N}^{_{ƒ}}. A 2D CNN g_{rgb} is used to render the feature map to an RGB image I_{rgb}:

g_{rgb}:F∈ [symbol] ^{H}^{_{ƒ}}^{×W}^{_{ƒ}}^{×N}^{_{ƒ}}→I_{rgb}∈ [symbol] ^{H×W×3}. (4)

In practice, a smaller spatial resolution for the feature map H_{ƒ}×W_{ƒ} than that of the rendered image H×W, and rely on the CNN g_{rgb} for upsampling. Thus, the number of ray queries is significantly reduced.

LiDAR simulation may be performed as follows. LiDAR point clouds encode 3D (depth) and intensity (reflectivity) information, both of which can be simulated in a similar fashion to Eq. 3. One or more embodiments assume the LiDAR to be a time-of-flight pulse-based sensor, and model the pulses transmitted by the oriented LiDAR laser beams as a set of rays. One or more embodiments slightly abuse the notation and let r(t)=o+td be a ray casted from the LiDAR sensor one or more embodiments want to simulate. Denote o as the center of the LiDAR and d as the normalized vector of the corresponding beam. One or more embodiments then simulate the depth measurement by computing the expected depth of the sampled 3D points:

$$D ( r ) = {\sum }_{i = 1}^{{N}_{r}} {w}_{i} {t}_{i} . \qquad ( 5 )$$

As for LiDAR intensity, one or more embodiments volume render the ray feature (using Eq. 3) and pass it through an MLP intensity decoder gᵢₙₜ to predict its intensity [symbol] ^{int}(r)=gᵢₙₜ(f(r)).

Training of the rendering system may be performed as follows. One or more embodiments jointly optimize all feature grids of features [symbol] (including latent codes [symbol] the hypernetwork f_{z}, the MLP heads (f_{bg}, f_{A}) and the decoders (g_{rgb}, gᵢₙₜ) by minimizing the difference between the sensor observations and our rendered outputs. One or more embodiments also regularize the underlying geometry such that it satisfies real-world constraints. The loss function is:

[symbol]

= [symbol] _{rgb}+λ_{lidar} [symbol] _{lidar}+λ_{reg} [symbol] _{reg}+λ_{adv} [symbol] _{adv}.

Each term of the loss function is described below.

The image simulation loss (i.e., camera image loss) [symbol] _{rgb} includes of an l₂ photometric loss and a perceptual loss, both measured between the observed images and simulated images. The loss may be calculated in a patch-wise fashion:

$${\text{?}}_{rgb} = \frac{1}{{N}_{rgb}} {\sum }_{i = 1}^{{N}_{rgb}} ( {‖ {I}_{i}^{rgb} - {\hat{I}}_{i}^{rgb} ‖}_{2} + λ {\sum }_{j = 1}^{M} {‖ {V}^{j} ( {I}_{i}^{rgb} ) - {V}^{j} ( {\hat{I}}_{i}^{rgb} ) ‖}_{1} ) , \qquad ( 6 )$$

where

$${I}_{i}^{rgb} = {f}_{rgb} ( {F}_{i} )$$

is the rendered image patch (Eq. 4) and

$${\hat{I}}_{i}^{rgb}$$

is the corresponding observed image patch. V^{j} denotes the j-th layer of a pre-trained VGG network.

The LiDAR loss [symbol] _{lidar} may be calculated as follows. LiDAR loss is the l₂ error between the observed LiDAR point clouds and the simulated ones. Specifically, one or more embodiments compute the depth and intensity differences:

$${\text{?}}_{lidar} = \frac{1}{N} {\sum }_{i = 1}^{N} ( {‖ D ( {r}_{i} ) - {D}_{i}^{obs} ‖}_{2} + {‖ {l}^{int} ( {r}_{i} ) - {\hat{l}}_{i}^{int} ‖}_{2} ) , \qquad ( 7 )$$

Since LiDAR observations are noisy, one or more embodiments filter outliers and encourage the model to focus on credible supervision. In practice, one or more embodiments optimize 95% of the rays within each batch that have a smallest depth error.

The regularization term [symbol] _{reg} may be calculated as follows. One or more embodiments further apply two additional constraints on the learned representations. First, one or more embodiments encourage the learned sample weight distribution w (Eq. 3) to concentrate around the surface. Second, one or more embodiments encourage the underlying SDF s to satisfy the Eikonal equation, which helps the network optimization find a smooth zero level set:

$${\text{?}}_{reg} = \frac{1}{N} {\sum }_{i = 1}^{N} ( {\sum }_{{τ}_{i , j} > ϵ} {‖ {w}_{ij} ‖}_{2} + {\sum }_{{τ}_{i , j} < ϵ} {( {‖ ∇ s ( {x}_{ij} ) ‖}_{2} - 1 )}^{2} ) , \qquad ( 8 )$$

where

$${τ}_{i , j} = \vert {t}_{ij} - {D}_{i}^{gt} \vert$$

is the distance between the sample xᵢⱼ and its corresponding LiDAR observation

$${D}_{i}^{gt}$$

Adversarial loss [symbol] _{adv} may be used to improve photorealism at unobserved viewpoints. Specifically, one or more embodiments train a discriminator CNN [symbol] _{adv} to differentiate between the simulated images at observed viewpoints and unobserved ones. Specifically, one or more embodiments denote the set of rays to render an image patch as

$$R = {\{ r ( o , {d}_{j} ) \}}_{j = 1}^{P \times P} ,$$

and randomly jitter the ray origin to create unobserved ray patches

$${R}^{′} = {\{ r ( o + ϵ , {d}_{j} ) \}}_{j = 1}^{P \times P} , where ϵ ∈ 𝒩 ( 0 , σ ) .$$

The discriminator CNN patches [symbol] _{adv} minimizes:)

$$- \frac{1}{{N}_{adv}} {\sum }_{i = 1}^{{N}_{adv}} log {\text{?}}_{adv} ( {I}_{i}^{rgb , R} ) + log ( 1 - {\text{?}}_{adv} ( {I}_{i}^{rgb , R ′} ) ) , \qquad ( 9 )$$

where

$${I}_{i}^{rgb , R} = {f}_{rgb} ( F ( {R}_{i} ) ) and {I}_{i}^{rgb , R ′} = {f}_{rgb} ( F ( {R}_{i}^{′} ) )$$

are the rendered image patches at observed and unobserved viewpoints, respectively. One or more embodiments then define the adversarial loss [symbol] _{adv} to train the CNN RGB decoder g_{rgb} and neural feature fields to improve photorealism at unobserved viewpoints as:

$${\text{?}}_{adv} = \frac{1}{{N}_{adv}} {\sum }_{i = 1}^{{N}_{adv}} log ( 1 - {\text{?}}_{adv} ( {I}_{i}^{rgb , R ′} ) ) . \qquad ( 10 )$$

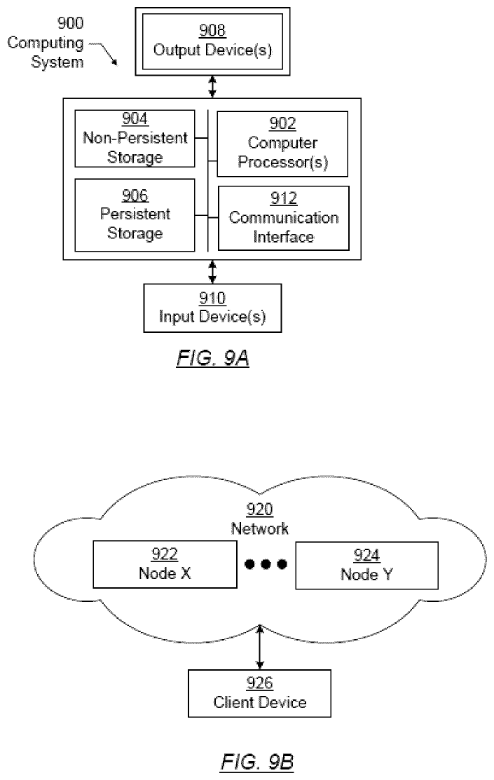

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 9A, the computing system (900) may include one or more computer processors (902), non-persistent storage (904), persistent storage (906), a communication interface (912) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) may be one or more cores or micro-cores of a processor. The computer processor(s) (902) includes one or more processors. The one or more processors may include a central processing unit (CPU), a graphics processing unit (GPU), a tensor processing unit (TPU), combinations thereof, etc.

The input devices (910) may include a touchscreen, keyboard, mouse, microphone, touchpad, electronic pen, or any other type of input device. The input devices (910) may receive inputs from a user that are responsive to data and messages presented by the output devices (908). The inputs may include text input, audio input, video input, etc., which may be processed and transmitted by the computing system (900) in accordance with the disclosure. The communication interface (912) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the output devices (908) may include a display device, a printer, external storage, or any other output device. One or more of the output devices may be the same or different from the input device(s). The input and output device(s) may be locally or remotely connected to the computer processor(s) (902). Many different types of computing systems exist, and the aforementioned input and output device(s) may take other forms. The output devices (908) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (900) in FIG. 9A may be connected to or be a part of a network. For example, as shown in FIG. 9B, the network (920) may include multiple nodes (e.g., node X (922), node Y (924)). Each node may correspond to a computing system, such as the computing system shown in FIG. 9A, or a group of nodes combined may correspond to the computing system shown in FIG. 9A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9A. Further, the client device (926) may include and/or perform all or a portion of one or more embodiments.

The computing system of FIG. 9A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A computer-implemented method comprising:
interpolating a plurality of hash grid features adjacent to a location in a neural hash grid defined for a target object to obtain a set of location features;
processing, by a multilayer perceptron (MLP) model, the set of location features to generate a set of image features for the location;
completing, using the set of image features, ray casting to the target object to generate a feature image;
generating a rendered image from the feature image; and
processing the rendered image.

2. The computer-implemented method of claim 1, further comprising:
executing a convolutional neural network (CNN) decoder on the feature image to generate the rendered image.

3. The computer-implemented method of claim 2, wherein the completing the ray casting to generate the feature image generates the feature image in a first resolution, wherein the CNN decoder upscales the feature image in the first resolution to a second resolution when generating the rendered image.

4. The computer-implemented method of claim 2, wherein the completing the ray casting to generate the feature image corrects a rendering artifact in the feature image.

5. The computer-implemented method of claim 1, further comprising:
executing a LiDAR decoder using an object appearance generated from the neural hash grid to generate a LiDAR point cloud.

6. The computer-implemented method of claim 1, further comprising:
determining that the target object is intercepted by a ray during the ray casting; and
selecting, from a plurality of neural hash grids for a plurality of objects, the neural hash grid matching the target object based on the target object being intercepted by the ray.

7. The computer-implemented method of claim 1, further comprising:
initializing the neural hash grid with the plurality of hash grid features set to a plurality of random values;
calculating a loss based on a difference between the neural hash grid and a sensor image; and
backpropagating the loss through the MLP model and the neural hash grid to update the plurality of hash grid features.

8. The computer-implemented method of claim 7, wherein the plurality of random values is used to initialize nonempty portions of the neural hash grid, and wherein empty portions of the neural hash grid are initialized with a predefined value.

9. The computer-implemented method of claim 7, further comprising:
executing a convolutional neural network (CNN) decoder on the feature image to generate the rendered image; and
comparing, after generating the rendered image, the rendered image to a real image to generate an image loss,
wherein calculate the loss uses the image loss.

10. The computer-implemented method of claim 9, wherein comparing the rendered image to the real image comprises:
detecting a plurality of differences between pixels of the rendered image with corresponding pixels of the real image; and
calculating the image loss based on the plurality of differences.

11. The computer-implemented method of claim 1, further comprising:
executing a convolutional neural network (CNN) decoder on the feature image to generate the rendered image;
partitioning, after generating the rendered image, the rendered image into a plurality of image patches;
partitioning a real image into a plurality of real image patches;
executing a discriminator model on the plurality of image patches and the plurality of real image patches to predict a plurality of classifications;
generating a discriminator loss based on the plurality of classifications that are inaccurate;
generating a CNN loss based on the plurality of classifications that are accurate;
updating the CNN using the CNN loss; and
updating the discriminator model using the discriminator loss.

12. The computer-implemented method of claim 1, further comprising:
modeling each of a plurality of objects with corresponding latent code to generate a plurality of constraint vectors for the plurality of objects;
training a hypernetwork to use the corresponding latent code in a constraint vector of the plurality of constraint vectors corresponding to the object; and
jointly optimizing the plurality of constraint vectors across the plurality of objects to constrain a representation of the object.

13. The computer-implemented method of claim 1, further comprising:
jointly optimizing a rotation and a translation component of a pose of the target object at each of a plurality of timesteps.

14. A system comprising:
memory; and
a computer processor comprising computer readable program code for performing operations comprising:
interpolating a plurality of hash grid features adjacent to a location in a neural hash grid defined for a target object to obtain a set of location features;
processing, by a multilayer perceptron (MLP) model, the set of location features to generate a set of image features for the location;
completing, using the set of image features, ray casting to the target object to generate a feature image;
generating a rendered image from the feature image; and
processing the rendered image.

15. The system of claim 14, wherein the operations further comprise:
executing a convolutional neural network (CNN) decoder on the feature image to generate the rendered image.

16. The system of claim 15, wherein the completing the ray casting to generate the feature image generates the feature image in a first resolution, wherein the CNN decoder upscales the feature image in the first resolution to a second resolution when generating the rendered image.

17. The system of claim 15, wherein the completing the ray casting to generate the feature image corrects a rendering artifact in the feature image.

18. The system of claim 14, wherein the operations further comprise:
executing a LiDAR decoder using an object appearance generated from the neural hash grid to generate a LiDAR point cloud.

19. A non-transitory computer readable medium comprising computer readable program code for performing operations comprising:
interpolating a plurality of hash grid features adjacent to a location in a neural hash grid defined for a target object to obtain a set of location features;
processing, by a multilayer perceptron (MLP) model, the set of location features to generate a set of image features for the location;
completing, using the set of image features, ray casting to the target object to generate a feature image;
generating a rendered image from the feature image; and
processing the rendered image.

20. The non-transitory computer readable medium of claim 19, wherein the operations further comprise:
executing a convolutional neural network (CNN) decoder on the feature image to generate the rendered image.
